(19) United States
(12) Patent Application Publication
(10) Pub. No.: US 2025/0088864 A1
(43) Pub. Date: Mar. 13, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 18/961,618

(22) Filed: Nov. 27, 2024

Related U.S. Application Data
(63) Continuation of application No. PCT/CN2022/097888, filed on Jun. 9, 2022.

(51) Int. Cl. H04W 16/22

(52) U.S. Cl. CPC H04W 16/22

(57) ABSTRACT

An information transceiving apparatus, applicable to a terminal equipment, includes: a transmitter configured to transmit third information for acquiring an AI model to a network device; and a receiver configured to receive fourth information transmitted by the network device in response to the third information.

### CROSS-REFERENCE TO RELATED APPLICATION

This application is a continuation application of International Application PCT/CN2022/097888 filed on Jun. 9, 2022, and designated the U.S., the entire contents of which are incorporated herein by reference.

### TECHNICAL FIELD

This disclosure relates to the field of communication technologies.

### BACKGROUND

In order to support different application scenarios and provide different types of services, it is expected that wireless networks are more intelligent with respect to design, deployment and operation. However, with the increasing complexity of 5G New Radio (NR) networks, traditional methods of network design, deployment and operation are becoming increasingly difficult to meet demands of intelligence. Artificial intelligence (AI) and machine learning (ML) technologies provide important means for optimizing 5G New Radio networks.

With the development of AI/ML technologies, applying AI/ML technologies to physical layers of wireless communications to optimize such difficulties as latency, load and accuracy in existing systems has become a direction of existing technologies.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that when various AI models with different functions, performances and/or complexities are stored in a network, how a terminal equipment acquires a suitable AI model is a problem needing to be solved.

In order to solve at least one of the above problems, embodiments of this disclosure provide an information transceiving method and apparatus.

According to one aspect of the embodiments of this disclosure, there is provided an information transceiving apparatus, including:
a first transmitting unit configured to transmit request information for acquiring an AI model to a network device; and
a first receiving unit configured to receive feedback information transmitted by the network device in response to the request information.

According to another aspect of the embodiments of this disclosure, there is provided an information transceiving apparatus, including:
a second receiving unit configured to receive request information transmitted by a terminal equipment for acquiring an AI model; and
a second transmitting unit configured to transmit feedback information in response to the request information to the terminal equipment.

According to a further aspect of the embodiments of this disclosure, there is provided a communication system, including a terminal equipment and/or a network device, the terminal equipment including the information transceiving apparatus as described in the one aspect, and the network apparatus including the information transceiving apparatus as described in the other aspect.

An advantage of the embodiments of this disclosure exists in that the terminal equipment transmits request information for acquiring an AI model to the network device, and receives feedback information transmitted by the network device. Hence, the terminal equipment is able to acquire a suitable AI model from the network device, and may optimize the payload and latency of the system by using the acquired AI model.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of the information transceiving method of embodiments of this disclosure;

FIG. 3 is a schematic diagram of functional modules of a receive link/transmit link of the terminal equipment of embodiments of this disclosure;

FIG. 4 is a schematic diagram of the relevant identifier information of embodiments of this disclosure;

FIG. 5 is a schematic diagram of the information transceiving method of embodiments of this disclosure;

FIG. 6 is a schematic diagram of the information transceiving method of embodiments of this disclosure;

FIG. 7 is a schematic diagram of the information transceiving apparatus of embodiments of this disclosure;

FIG. 8 is a schematic diagram of the information transceiving apparatus of embodiments of this disclosure;

FIG. 9 is a schematic diagram of the information transceiving method of embodiments of this disclosure;

FIG. 10 is a schematic diagram of the network device of embodiments of this disclosure; and

FIG. 11 is a schematic diagram of the terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, New Radio (NR), and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” may refer to a network device, and may also refer to a terminal equipment, except otherwise specified.

Scenarios in the embodiments of this disclosure shall be described below by way of examples; however, this disclosure is not limited thereto.

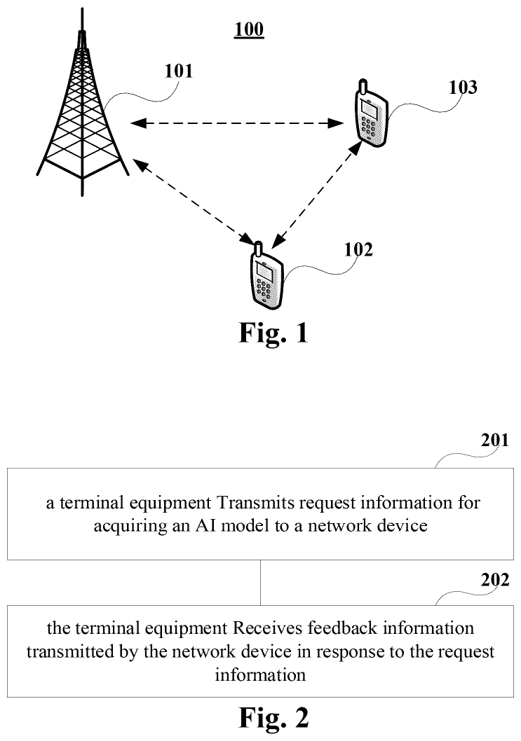

FIG. 1 is a schematic diagram of a communication system of an embodiment of this disclosure, in which a case where terminal equipment and a network device are taken as examples is schematically shown. As shown in FIG. 1, the communication system 100 may include a network device 101 and terminal equipment 102, 103. For the sake of simplicity, an example having only two terminal equipment and one network device is schematically given in FIG. 1; however, the embodiments of this disclosure are not limited thereto.

In the embodiment of this disclosure, existing services or services that may be implemented in the future may be performed between the network device 101 and the terminal equipment 102, 103. For example, such services may include but not limited to an enhanced mobile broadband (eMBB), massive machine type communication (MTC), and ultra-reliable and low-latency communication (URLLC), etc.

It should be noted that FIG. 1 shows that two terminal equipment 102, 103 are both in coverage of the network device 101. However, this disclosure is not limited thereto, and the two terminal equipment 102, 103 may not be in coverage of the network device 101, or one terminal equipment 102 is in coverage of the network device 101 and the other terminal equipment 103 is out of coverage of the network device 101.

In the embodiment of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

An AI model includes but are not limited to an input layer (input), multiple convolutional layers, a concatenation layer (concat), a fully connected layer (FC), and a quantizer, etc., processing results of the multiple convolutional layers are merged in the concatenation layer. Reference may be made to existing techniques for a specific structure of the AI model, which shall not be repeated herein any further.

It was found by the inventors that AI models with different functions, parameters and/or complexities may be trained in an off-line manner. After training, due to limitations on a storage capacity of a terminal equipment, it is usually considered to store these AI models only in a network device. However, a method of how a terminal equipment acquires an AI model is not defined in existing standards. Addressed to the above problem, embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a terminal equipment side.

FIG. 2 is a schematic diagram of the information transceiving method of the embodiments of this disclosure. As shown in FIG. 2, the method includes:
201: a terminal equipment transmits request information for acquiring an AI model to a network device; and
202: the terminal equipment receives feedback information transmitted by the network device in response to the request information.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, multiple AI models with different functions, parameters and/or complexities may be stored in the network device, that is, multiple AI models are pre-stored in the network device.

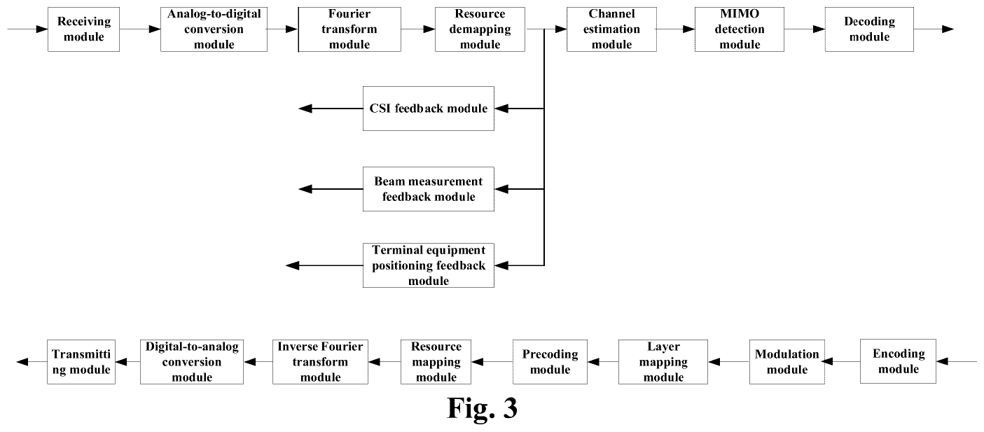

In some embodiments, the function of the AI model refers to a part of functions in a receiving link and/or transmitting link of the terminal equipment. FIG. 3 is a schematic diagram of functional modules of the receiving link and transmitting link of the terminal equipment of the embodiments of this disclosure. As shown in FIG. 3, in the receiving link, following functional modules are included: a receiving module, an analog-to-digital conversion module, a Fourier transform module, a resource demapping module, a channel state information (CSI) feedback module, a beam measurement feedback module, a terminal equipment positioning feedback module, a channel estimation module, a multiple input multiple output (MIMO) detection module, and a decoding module; and in the transmitting link, the following functional modules are included: a transmitting module, a digital-to-analog conversion module, an inverse Fourier transform module, a resource mapping module, a precoding module, a layer mapping module, a modulation module, and an encoding module.

In some embodiments, the function of the AI model includes an AI encoder model for CSI compression (or encoding) or an AI model for beam prediction or an AI model for terminal equipment positioning.

For example, as shown in FIG. 3, in the CSI feedback module, if a typeII or etypeII codebook defined in existing standards is used for CSI feedback, a feedback payload is relatively large. If the AI model may be used to compress eigenvectors of a channel coefficient matrix or a channel coefficient matrix, the payload of the CSI feedback may be reduced, and overhead of the CSI feedback may be lowered. Therefore, in the CSI feedback module, the terminal equipment may use the AI model (also referred to as an AI encoder) for CSI compression (or encoding).

For example, as shown in FIG. 3, in the beam measurement feedback module, methods defined in existing standards are adopted for beam measurement and feedback. When beam scanning is performed on all synchronization signal blocks (SSBs), a payload of an RS and latency of beam selection are relatively large. A spatially optimal beam may be predicted by using the AI model according to measurement results of a small number of beams, which may reduce the payload of the RS and the delay of the beam selection. Hence, in the beam measurement feedback module, the terminal equipment may predict the optimal beam by using the AI model.

For example, as shown in FIG. 3, in the terminal equipment positioning feedback module, if a related method is used for positioning of the terminal equipment, the terminal equipment is unable to effectively recognize line-of-sight (LOS) transmission and non-line-of-sight (NLOS) transmission scenarios, which will result in relatively low positioning accuracy. The AI model may be used to effectively classify whether a current scenario of the terminal equipment is LOS or NLOS, which may improve accuracy of the positioning. Hence, in the terminal equipment positioning feedback module, the terminal equipment may use the AI model for terminal equipment positioning.

What described above is an example only, and the AI model may also be used in other functional modules of the receiving link and/or transmitting link of the terminal equipment. That is, the function of the AI model may further include a part of functions in the receiving link and/or transmitting link of the terminal equipment in addition to those in the above example, which shall not be enumerated herein any further.

In some embodiments, the parameters of the AI model refer to input parameters and output parameters of the AI model, the input parameters and output parameters including a dimension and physical quantity of input or output. Parameters of AI models with same functions be identical or different (for example, dimensions in the input/output parameters may be identical or different, and the physical quantities of the input/output may be identical or different). For example, for an AI encoder model used for CSI compression, a physical quantity of its input parameter may be an eigenvector representing a channel coefficient matrix, and may also be a channel coefficient matrix, and its dimension is X1×Y1×Z1×N; and a physical quantity of its output parameter may be a compressed channel eigenvector, or a channel coefficient matrix, and its dimension is X2. For example, if the number of transmit antenna ports of the network device is 32, the number of receiving antenna ports of the terminal equipment is 2, a bandwidth of a communication system is 24 resource blocks (RBs), and a density of channel state information reference signal (CSI-RS) in a frequency domain is 0.5, i.e. there is one CSI-RS signal on 2 RBs, there are total 12 CSI-RS signals in the frequency domain. The dimension of the channel coefficient matrix of the physical quantity of the input parameter is 12×32×2×2 (i.e. the number of RSs in the frequency domain×the number of transmitting antenna ports of the network device×the number of receiving antenna ports of the terminal equipment×I/Q paths). For another example, for an AI model used for beam prediction, a physical quantity of its input parameter is an RSRP (reference signal receiving power) value of some beam pairs, and may also be an SINR (signal to interference plus noise ratio) value of some beam pairs, an input dimension is X1, and a physical quantity of its output parameter is RSRP or an SINR of all beam pairs, and an output dimension is X2. For example, there are 12 downlink transmitting beams and 8 receiving beams, and there are total 96 beam pairs. Through configuration, the UE only measures RSRP of 24 beams. At this time, the dimension of the input parameter of the AI model is 24, and its physical quantity is the RSRP, while the dimension of the output parameter of the AI model is 96, and its physical quantity is also the RSRP.

In some embodiments, the complexity of the AI model refers to a second calculation amount and/or a second storage space actually on-demand in deploying the AI model. The calculation amount be expressed by floating point operations per second (FLOPs), the second calculation amount actually on-demand in deploying the AI model is related to input and output parameters (dimensions, and channels, etc.), and a convolution kernel size, etc., of the AI model, and reference may be made to the related art for a method of determination thereof, and the second storage space actually on-demand in deploying the AI model is related to a size of the AI model (i.e. the number of bits/bytes/megabytes occupied in deploying the AI model) and feature consumption (an intermediate or final output result), and reference may be made to the related art for a method of determination thereof.

In some embodiments, different AI models mean that at least one of functions, parameters and/or complexities of the AI models are different. For example, if a function of AI model A is used for CSI compression and a function B of AI model B is used for beam prediction, AI model A and AI model B are different AI models. For example, if functions of AI model A and AI model B are both used for CSI compression but their complexities are different and/or parameters thereof are different, AI model A and AI model B are different AI models.

In some embodiments, the terminal equipment needs to use a suitable (corresponding) AI model in executing some functions in its receiving link and/or transmitting link. As multiple AI models are pre-stored in the network device and the terminal equipment does not store these multiple AI models, the terminal equipment may acquire a needed model by transmitting request information for acquiring AI models to the network device, the request information including function identifier information of the AI model and/or parameter information of the AI model and/or capability information of the AI model that the terminal equipment is able to support.

In some embodiments, the function identifier information of the AI model is used to identify the functions of the AI model. For example, the function identifier information is 3 bits, and different bit values represent different functions of the AI model. A correspondence between values of the bits and the functions of the AI model may be predefined in the terminal equipment and the network device, and a function of the AI model needed (requested) by the terminal equipment is indicated according to the function identifier information. For example, when the function identifier information is 001, the needed (requested) function of the AI model is for CSI compression, when the function identifier information is 010, the needed (requested) function of the AI model is for beam prediction, and when the function identifier information is 011, the needed (requested) function of the AI model is for terminal equipment positioning; or, for example, the function identifier information may be a bitmap, each bit correspondingly indicating a function of an AI model. When a value of a bit is 1 (or 0), it indicates that the needed (requested) function of the AI model is a function of an AI model to which the bit corresponds. For example, the function identifier information is a 3-bit bitmap, a correspondence between bits and the functions of the AI model may be predefined in the terminal equipment and the network device, and a function of the AI model needed (requested) by the terminal equipment is indicated according to the function identifier information. For example, when the function identifier information is 001, the needed (requested) function of the AI model is for CSI compression, when the function identifier information is 010, the needed (requested) function of the AI model is for beam prediction, and when the function identifier information is 100, the needed (requested) function of the AI model is for terminal equipment positioning. What described above is an example only, and the embodiments of this disclosure are not limited thereto.

In some embodiments, as described above, the parameter information of the AI model includes information of input parameter and output parameter of the AI model, the information of input parameter and output parameter including first information indicating dimensions of the input and output, and/or second information indicating physical quantities of the input and output. The first information indicates the number of dimensions and/or specific numerical values of the dimensions. The number of dimensions may be explicitly or implicitly indicated, for example, it is indicated by a first predetermined number (e.g. 2) of bits; where, 01 indicates that the input dimension is X2, and 11 indicates that the input dimension is X1×Y1×Z1×N; and a second predetermined number of bits is used to respectively indicate a specific numerical value of each dimension, that is, the specific numerical value of each dimension is represented by using binary encoding. For example, a value of X1 is indicated by using 3 bits, a value of Y1 is indicated by using 3 bits, a value of Z1 is indicated by using 3 bits, and a value of N is indicated by using 3 bits. What described above is an example only, and the embodiments of this disclosure are not limited thereto. For example, the first predetermined number of bits may also be default, and the number of dimensions may be implicitly indicated by using the above second predetermined number of bits, which shall not be enumerated herein any further. The second information is represented by using a third predetermined number of bits, different bit values representing different physical quantities, and a correspondence between the values of the bits and the physical quantities may be predefined in the terminal equipment and the network device. For example, when the second information is 001, it indicates that the physical quantity is the channel coefficient matrix, and when the second information is 010, it indicates that the physical quantity is RSRP, which shall not be enumerated herein any further. In some embodiments, the capability information includes a maximum first calculation amount and/or a first storage space that the terminal equipment is able to support for deployment of the AI model. Similar to what is described above, the first calculation amount may be expressed by floating point operations per second (FLOPs) (e.g. binary encoding), the first storage space may be expressed by bits/bytes/megabits, etc. (e.g. binary encoding), and specific value(s) of the maximum first calculation amount and/or the first storage space that the terminal equipment is able to support for deployment of the AI model is/are determined by a capability of the terminal equipment (such as hardware (e.g. a processor, and a memory, etc.) performance and a program or service or function that is currently run/executed, which shall not be enumerated herein any further.

For example, after receiving a CSI RS transmitted by the network device, the terminal equipment needs to perform CSI estimation and reporting. In order to reduce a load of CSI feedback and lower overhead of CSI feedback, the terminal equipment needs to acquire an AI model for CSI compression, and obtain compressed CSI by using the AI model. Hence, the terminal equipment may transmit request information for acquiring an AI model for CSI compression to the network device, or, in other words, the terminal equipment may request the network device for acquiring an AI model for CSI compression, the request information including function identifier information of the AI model for CSI compression and/or parameter information of the AI model and/or capability information of the AI model for CSI compression that the terminal equipment is able to support.

For example, the terminal equipment receives a reference signal for beam measurement transmitted by the network device, and in order to reduce the payload of the RS and latency in beam selection, the terminal equipment needs to obtain an AI model for beam prediction, uses the AI model to predict an optimal beam, and transmits information on the optimal beam to the network device. Hence, the terminal equipment may transmit a request information for acquiring an AI model for beam prediction to the network device, or, in other words, the terminal equipment may request the network device for acquiring an AI model for beam prediction, the request information including function identifier information of the AI model for beam prediction and/or parameter information of the AI model and/or capability information of the AI model for beam prediction that the terminal equipment is able to support.

For example, in order to improve positioning accuracy, the terminal equipment needs to acquire an AI model for terminal equipment positioning, and uses the AI model to effectively classify whether a current scenario in which the terminal equipment is located is LOS or NLOS. Hence, the terminal equipment may transmit request information for acquiring an AI model for terminal equipment positioning to the network device, or, in other words, the terminal equipment may request the network device for acquiring an AI model for terminal equipment positioning, the request information including function identifier information of the AI model for terminal equipment positioning and/or parameter information of the AI model and/or capability information of the AI model for terminal equipment positioning that the terminal equipment is able to support.

In some embodiments, the request information is carried by RRC or an MAC CE or UCI. For example, the request information may be a newly-added information element (field) in the UCI or existing RRC signaling, or the request information may be carried by newly-added RRC signaling, which shall not be enumerated herein any further. The number of bits of the information in the above request information is an example only, and the embodiments of this disclosure are not limited thereto.

In some embodiments, after receiving the request information, the network device may transmit feedback information to the terminal equipment in response to the request information.

In some embodiments, after receiving the request information, the network device may transmit the feedback information to the terminal equipment, and matches multiple pre-stored AI models according to the request information. If no AI model satisfying the request of the terminal equipment is found (matching fails), the network device informs the terminal equipment via the feedback information that the request of the terminal equipment is not supported, and if an AI model satisfying the request of the terminal equipment is found (matching succeeds), the network device informs the terminal equipment via the feedback information that the request of the terminal equipment is supported, so as to inform the terminal equipment of relevant information of the matched AI model.

A method for matching AI models by the network device shall be described below first.

For example, if the request information includes the function identifier information of the AI model and/or the parameter information of the AI model and/or the capability information of the

AI model that the terminal equipment is able to support, after receiving the request information, the network device performs matching on multiple AI models pre-stored in it according to the function identifier information in the request information, and attempts to match an AI model with the same function as a function of an AI model indicated by the function identifier information. If there exists no AI model with the same function as the function of the AI model indicated by the function identifier information, that is, the matching fails, it indicates that the network device does not support the request of the terminal equipment. If there are multiple AI models with the same function as the function of the AI model indicated by the function identifier information, the network device performs matching on multiple AI models with the same function pre-stored in it according to the parameter information in the request information, and attempts to match an AI model with the same parameters as an AI model indicated by the parameter information of the AI model. If there exists no AI model with the same parameter as the AI model indicated by the parameter information, that is, the matching fails, it indicates that the network device does not support the request of the terminal equipment. If there exist multiple AI models with matching parameters (having same parameters) in multiple AI models with the same function, the network device compares a second calculation amount and/or a second storage space of the multiple AI models having the same function and matching parameters with the first calculation amount and/or the first storage space in the capability information again. If the second calculation amount and/or the second storage space of the multiple AI models having the same function and matching parameters are all greater than the first calculation amount and/or first storage space, it indicates that the capability of the terminal equipment is unable to support deployment of the AI model (matching fails). If a second calculation amount and/or a second storage space of at least one AI model is/are less than the first calculation amount and/or first storage space, it indicates that the capability of the terminal equipment is able to support deployment of the AI model and an AI model satisfying the request of the terminal equipment is matched (matching succeeds), and one AI model is selected from the at least one (M) AI model and taken as the matched AI model (hereinafter also referred to as a suitable AI model). If M is equal to 1, the one AI model is taken as the matched AI model. If M is greater than 1, any AI model may be selected from the M AI models and taken as the matched AI model, or one AI model may be selected from the MAI models according to a predetermined rule and taken as the matched AI model. For example, the predetermined rule may be an AI model with a smallest or largest second calculation amount and/or second storage space among the M AI models. What described above is an example only, and the embodiments of this disclosure are not limited thereto.

The above matching process is an example only, and the embodiments of this disclosure are not limited thereto. For example, when one of the function identifier information and the capability information is included in the request information, a part of the above matching process may be performed according to only the function identifier information or the capability information, which shall not be repeated herein any further.

In some embodiments, the feedback information includes indication information of whether the request of the terminal equipment is supported and/or relevant identifier information of the AI model and/or complexity of the AI model, wherein the indication information includes 1 bit, when a value of the 1 bit is 1, it indicates that the network device supports the request of the terminal equipment (i.e. matching succeeds), and when the value of the 1 bit is 0, it indicates that the network device does not support the request of the terminal equipment (i.e. matching fails), vice versa, and this disclosure is not limited thereto.

In some embodiments, when the network device supports the request of the terminal equipment (i.e. matching succeeds), the feedback information may further include the relevant identifier information of the AI model and/or the complexity of the AI model, and the AI model is the matched AI model (suitable AI model).

In some embodiments, the relevant identifier information of the AI model is used to identify the function of the AI model and/or parameter information of AI models with the same function and/or a sequence number of the AI model in multiple AI models with the same function and the same parameter. For example, the relevant identifier information of the AI model includes first identifier information and/or second identifier information and/or third identifier information, wherein the first identifier information is a function identifier of the AI model, the second identifier information is the parameter information of the AI models with the same function, and the third identifier information is the sequence number of the AI model in the multiple AI models with the same function and parameter. Reference may be made to the implementation of the above function identifier information for the first identifier information, and the second identifier information may include a predetermined number of bits. Values of the predetermined number of bits identify the parameter information of the AI models with the same function. A difference between the second identifier information and the parameter information in the above request information exists in that when the parameter information of the AI models with the same function is different, the second identifier information is also different. However, when the parameter information of the AI models with different functions is identical or different, the same second identifier information may be used. For example, for an AI model used for CSI compression, when the second identifier information is 1000, it indicates that an input dimension is 8, and when the second identifier information is 1010, it indicates that an input dimension is 10. For an AI model used for beam prediction, when the second identifier information is 1000, it indicates that an input dimension is 8, and when the second identifier information is 1010, it indicates that an input dimension is 12, that is, the second identifier information is only used to uniquely identify different parameter information of the AI models with the same function. The third identifier information may include a predetermined number of bits, and values of the predetermined number of bits identify a sequence number of each AI model with the same function and the same parameter. For example, there are four AI models with the same function and the same parameter, and their third identifier information is 00, 01, 10 and 11, respectively.

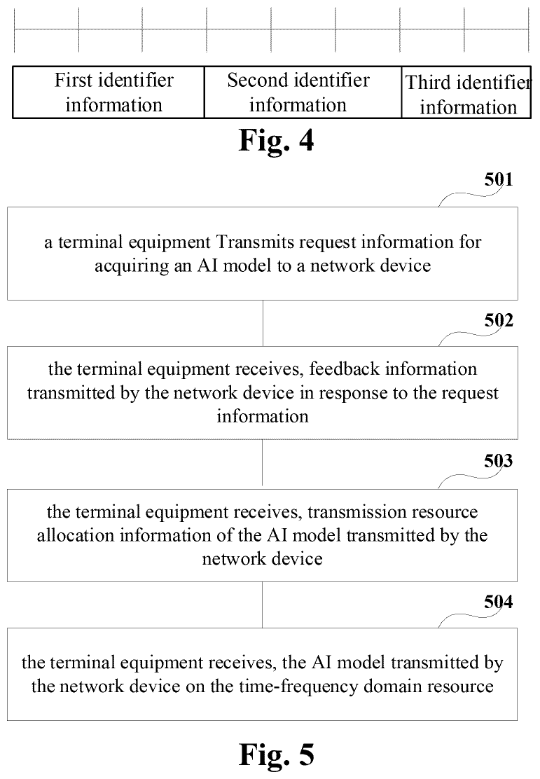

FIG. 4 is a schematic diagram of the relevant identifier information of the AI model in the embodiments of this disclosure. As shown in FIG. 4, the relevant identifier information is 8 bits, wherein former 3 bits are the first identifier information indicating the function of the AI model, intermediate 3 bits are the second identifier information indicating the parameter information of the model, and latter 2 bits are the third identifier information indicating the sequence number of the AI model in the multiple AI models with the same function and the same parameter. The above number of bits is an example only, and is not intended to limit this disclosure. In addition, the relevant identifier information may also be expressed in other forms. For example, the relevant identifier information may include fourth identification information, which is used to uniquely identify each AI model in the multiple AI models. For example, the relevant identifier information is 8 bits, wherein the 8 bits are the index of each AI model in the multiple AI models, which shall not be illustrated one by one herein any further.

In some embodiments, the complexity of the AI model includes a second calculation amount and/or a second storage space actually on-demand in deploying the AI model. Reference may be made to what is described above a meaning(s) and a mode(s) for determining the second calculation amount and/or the second storage space, and the second calculation amount and/or the second storage space may be included in the feedback information after binary encoding, which shall not be illustrated one by one herein any further.

In some embodiments, the feedback information is carried by RRC or an MAC CE or DCI. For example, the feedback information may be a newly-added information element (field) in the DCI or existing RRC signaling, or the feedback information may be carried by newly-added RRC signaling, which shall not be illustrated one by one herein any further.

FIG. 5 is a schematic diagram of the information transceiving method of the embodiments of this disclosure. As shown in FIG. 5, the method includes:
501: a terminal equipment transmits request information for acquiring an AI model to a network device;
502: the terminal equipment receives, feedback information transmitted by the network device in response to the request information;
503: the terminal equipment receives, transmission resource allocation information of the AI model transmitted by the network device, the resource allocation information being used for indicating a time-frequency domain resource needed in transmitting the AI model; and
504: the terminal equipment receives, the AI model transmitted by the network device on the time-frequency domain resource.

In some embodiments, reference may be made to 201-202 for implementations of 501-502, and repeated parts shall not be described herein any further.

In some embodiments, in 503, when the network device supports the request of the terminal equipment (matching succeeds), the network device transmits the resource allocation information to the terminal equipment. The resource allocation information is used to indicate a time-frequency domain resource (a resource on an air interface) needed in transmitting the AI model, a size of the time-frequency domain resource being determined according to a size (or, a second storage space) of the matched AI model. The AI model may be transmitted on a PDSCH, and the resource allocation information may be carried by DCI scheduling the PDSCH. For example, the resource allocation information may be a time domain and/or a frequency resource allocation field in the DCI, and reference may be made to the related art for details, which shall not be repeated herein any further. When the network device does not support the request of the terminal equipment (matching fails), 503-504 need not to be executed.

In some embodiments, in 504, after allocating the resource for transmission of the AI model, the network device transmits the AI model to the terminal equipment on the allocated time-frequency domain resource, wherein transmitting the AI model refers to transmitting a network structure, number of nodes, and coefficients of each node of the AI model, etc. For example, multiple trained AI models may be saved in predetermined storage formats in such development environments as PyTorch or TensorFlow as corresponding files in multiple predetermined formats, the files containing a network structure, the number of nodes and coefficients of each node of the AI model, files in multiple predetermined formats corresponding to the multiple AI models are pre-stored in the network device, and after matching the suitable AI model in 502, a file corresponding to the suitable AI model is transmitted to the terminal equipment on the allocated time-frequency domain resource.

In some embodiments, the method may further include (not shown): the terminal equipment performs corresponding processing by using the AI model, such as CSI compression, predicting an optimal beam, and positioning the terminal equipment (effectively classifying whether a current scenario where the terminal equipment is located is LOS or NLOS), etc., and reference may be made to the related art for details, which shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment transmits request information for acquiring an AI model to the network device, and receives the feedback information transmitted by the network device. Hence, the terminal equipment is able to acquire a suitable AI model from the network device, and may optimize the payload and latency of the system by using the acquired AI model.

### Embodiments of a Second Aspect

The embodiments of this disclosure provide an information transceiving method, which shall be described from a network device side, with contents identical to those in the embodiment of the first aspect being not going to be described herein any further.

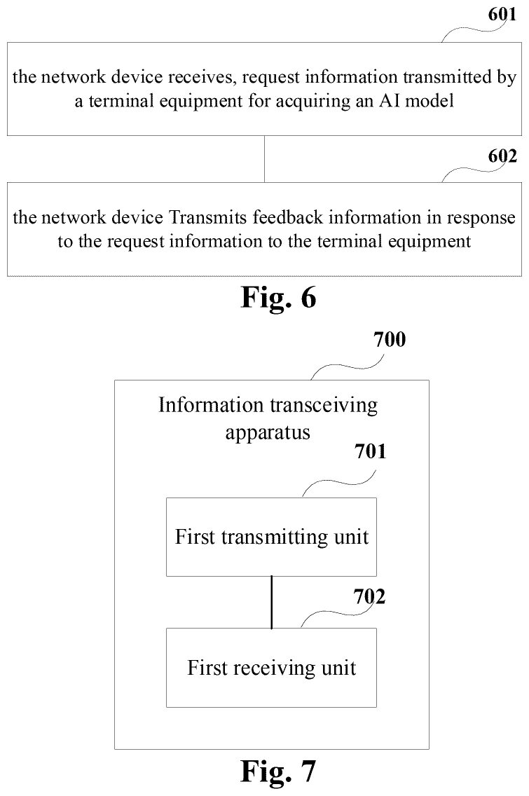

FIG. 6 is a schematic diagram of the information transceiving method of the embodiments of this disclosure. As shown in FIG. 6, the method includes:
601: the network device receives, request information transmitted by a terminal equipment for acquiring an AI model; and
602: the network device transmits feedback information in response to the request information to the terminal equipment.

In some embodiments, the request information includes function identifier information of the AI model and/or parameter information of the AI model and/or capability information of the AI model supported by the terminal equipment.

In some embodiments, the feedback information includes indication information on whether to support a request of the terminal equipment and/or relevant identifier information of the AI model and/or a complexity of the AI model.

Reference may be made to 201-202 for implementations of 601-602, and reference may be made to the embodiments of the first aspect for the request information and the feedback information, which shall not be described herein any further.

In some embodiments, the method further includes:
the network device matches with AI models stored in the network device b according to a function of the AI model and/or parameter information of the AI model and/or the capability information requested by the terminal equipment to determine whether there exists an AI model satisfying the request of the terminal equipment in the AI models stored in the network device; and
the network device transmits the feedback information based on a matching result of the processing unit.

In some embodiments, reference may be made to the matching process in the embodiment of the first aspect for implementation of the above matching, when the matching is successful, it is determined that there exists an AI model satisfying the request of the terminal equipment in the AI models stored in the network device, and when the matching fails, it is determined that there exists no AI model satisfying the request of the terminal equipment in the AI models stored in the network device. The network device transmits the feedback information based on the matching result of the processing unit. Reference may be made to the embodiments of the first aspect for details, which shall not be described herein any further.

In some embodiments, the method further includes:
the network device transmits transmission resource allocation information of the AI model to the terminal equipment, the resource allocation information being used to indicate a time-frequency domain resource needed in transmitting the AI model, and transmits the AI model to the terminal equipment on the time-frequency domain resource.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the network device receives the request information for acquiring an AI model transmitted by the terminal equipment, and transmits the feedback information to the terminal equipment. Hence, the terminal equipment is able to acquire a suitable AI model from the network device, and may optimize the payload and latency of the system by using the acquired AI model.

### Embodiments of a Third Aspect

The embodiments of this disclosure provide an information transceiving apparatus. The apparatus may be, for example, a terminal equipment, or one or some components or assemblies configured in the terminal equipment. Contents in this embodiment identical to those in the embodiment of the first aspect shall not be described herein any further.

FIG. 7 is a schematic diagram of the information transceiving apparatus of the embodiments of this disclosure. As shown in FIG. 7, an information transceiving apparatus 700 includes:
a first transmitting unit 701 configured to transmit request information for acquiring an AI model to a network device; and
a first receiving unit 702 configured to receive feedback information transmitted by the network device in response to the request information.

In some embodiments, the request information includes function identifier information of the AI model and/or parameter information of the AI model and/or capability information of the AI model supported by the terminal equipment.

In some embodiments, the capability information includes a maximum first calculation amount and/or a first storage space that the terminal equipment is able to support for deployment of the AI model.

In some embodiments, the feedback information includes indication information on whether to support a request of the terminal equipment and/or relevant identifier information of the AI model and/or a complexity of the AI model.

In some embodiments, the relevant identifier information of the AI model is used to identify a function of the AI model and/or parameter information of AI models with same function and/or an index of the AI model in multiple AI models with same function and same parameter.

In some embodiments, the relevant identifier information of the AI model includes first identifier information and/or second identifier information and/or third identifier information, the first identifier information being a function identifier of the AI model, the second identifier information being the parameter information of the AI models of same function, and the third identifier information being the sequence number of the AI model in the multiple AI models with same function and same parameter.

In some embodiments, the complexity of the AI model includes a second calculation amount and/or a second storage space actually on-demand in deploying the AI model.

In some embodiments, the request information is carried by RRC or an MAC CE or UCI.

In some embodiments, the feedback information is carried by RRC or an MAC CE or DCI.

In some embodiments, the function of the AI model refers to a part of functions in a receiving and/or transmitting link of the terminal equipment.

In some embodiments, the function of the AI model includes an AI encoder model for CSI compression or an AI model for beam prediction or an AI model for positioning the terminal equipment.

In some embodiments, the first receiving unit is further configured to receive transmission resource allocation information of the AI model transmitted by the network device, the resource allocation information being used for indicating a time-frequency domain resource needed in transmitting the AI model.

In some embodiments, the first receiving unit is further configured to receive the AI model transmitted by the network device on the time-frequency domain resource.

In some embodiments, the first receiving unit receives the resource allocation information when the network device supports the request of the terminal equipment.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the terminal equipment transmits request information for acquiring an AI model to the network device, and receives the feedback information transmitted by the network device. Hence, the terminal equipment is able to acquire a suitable AI model from the network device, and may optimize the payload and latency of the system by using the acquired AI model.

### Embodiments of a Fourth Aspect

The embodiments of this disclosure provide an information transceiving apparatus. The apparatus may be, for example, a network device, or one or some components or assemblies configured in the network device. Contents in this embodiment identical to those in the embodiment of the second aspect shall not be described herein any further.

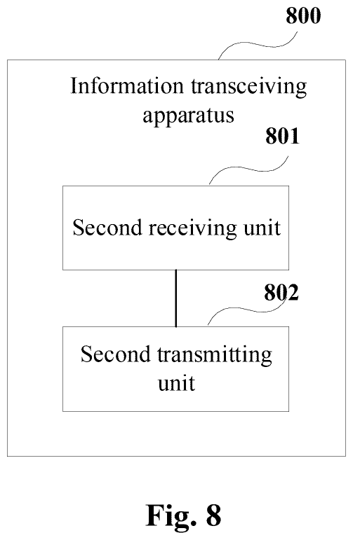

FIG. 8 is a schematic diagram of the information transceiving apparatus of the embodiments of this disclosure. As shown in FIG. 8, an information transceiving apparatus 800 includes:
a second receiving unit 801 configured to receive request information transmitted by a terminal equipment for acquiring an AI model; and
a second transmitting unit 802 configured to transmit feedback information in response to the request information to the terminal equipment.

In some embodiments, the request information includes function identifier information of the AI model and/or parameter information of the AI model and/or capability information of the AI model supported by the terminal equipment.

In some embodiments, the feedback information includes indication information on whether to support a request of the terminal equipment and/or relevant identifier information of the AI model and/or a complexity of the AI model.

In some embodiments, the apparatus further includes (not shown, optional):
a processing unit configured to match with AI models stored in the network device according to a function of the AI model and/or parameter information of the AI model and/or capability information requested by the terminal equipment to determine whether there exists an AI model satisfying the request of the terminal equipment in the AI models stored in the network device;
and the second transmitting unit transmits the feedback information based on a matching result of the processing unit.

In some embodiments, the second transmitting unit is further configured to transmit transmission resource allocation information of the AI model to the terminal equipment, the resource allocation information being used to indicate a time-frequency domain resource needed in transmitting the AI model, and transmit the AI model to the terminal equipment on the time-frequency domain resource.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 800 may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the network device receives the request information for acquiring an AI model transmitted by the terminal equipment, and transmits the feedback information to the terminal equipment. Hence, the terminal equipment is able to acquire a suitable AI model from the network device, and may optimize the payload and latency of the system by using the acquired AI model.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include:
a terminal equipment 102 configured to transmit request information for acquiring an AI model to the network device, and receive feedback information transmitted by the network device in response to the request information; and
a network device 101 configured to receive request information transmitted by the terminal equipment for acquiring an AI model, and transmit feedback information in response to the request information to the terminal equipment.

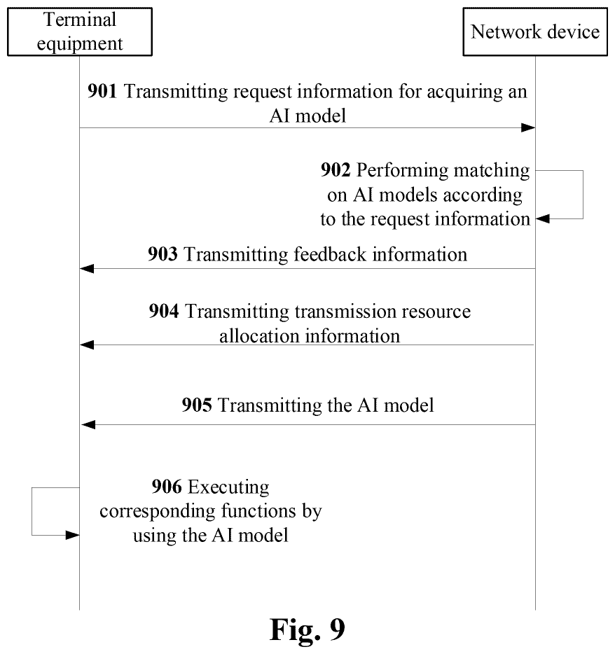

FIG. 9 is a schematic diagram of the information transceiving method of the embodiments of this disclosure. As shown in FIG. 9, the method includes:
901: the terminal equipment transmits request information for acquiring an AI model to the network device;
902: the network device performs matching on AI models according to the request information (performing selection of AI models);
903: the network device transmits feedback information to the terminal equipment according to a result of matching;
904: the network device transmits transmission resource allocation information of the AI model to the terminal equipment;
905: the network device transmits the AI model on the time-frequency domain resource to the terminal equipment; and
906: the terminal equipment executes corresponding functions (a part of functions in a receiving and/or transmitting link) by using the AI model.

Reference may be made to the embodiments of the first and second aspects for implementations of 901-906, which shall not be described herein any further.

The embodiments of this disclosure further provide a network device, which may be, for example, a base station. However, this disclosure is not limited thereto, and it may also be another network device.

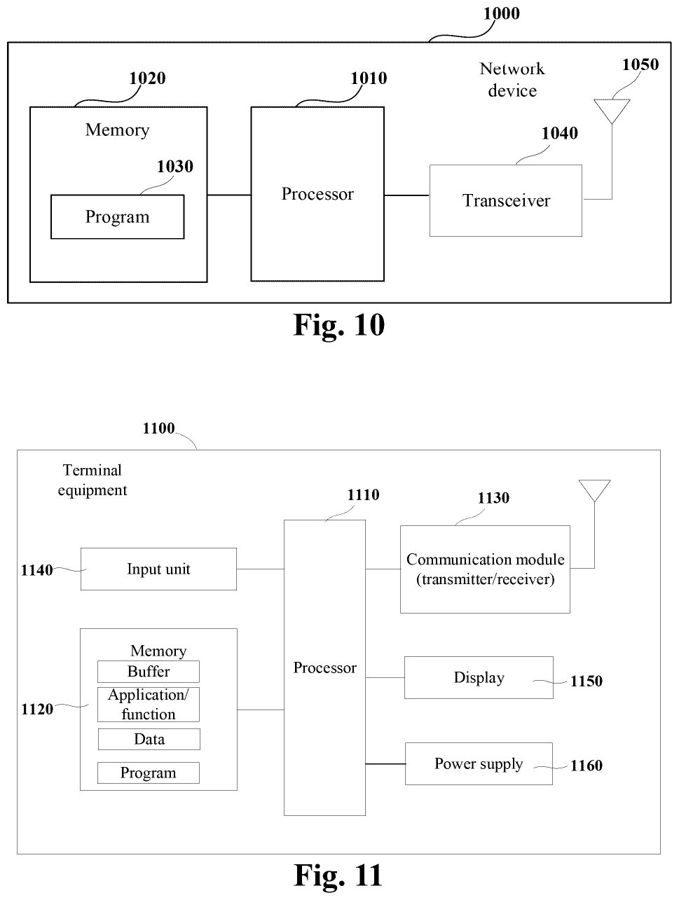

FIG. 10 is a schematic diagram of a structure of the network device of the embodiments of this disclosure. As shown in FIG. 10, a network device 1000 may include a processor 1010 (such as a central processing unit (CPU)) and a memory 1020, the memory 1020 being coupled to the processor 1010. The memory 1020 may store various data, and furthermore, it may store a program 1030 for information processing, and execute the program 1030 under control of the processor 1010.

For example, the processor 1010 may be configured to execute a program to carry out the information transceiving method described in the embodiment of the second aspect. For example, the processor 1010 may be configured to perform the following control: receiving request information transmitted by a terminal equipment for acquiring an AI model; and transmitting feedback information in response to the request information to the terminal equipment.

Furthermore, as shown in FIG. 10, the network device 1000 may include a transceiver 1040, and an antenna 1050, etc. Functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

The embodiments of this disclosure further provide a terminal equipment; however, this disclosure is not limited thereto, and it may also be another equipment.

FIG. 11 is a schematic diagram of the terminal equipment of the embodiments of this disclosure. As shown in FIG. 11, a terminal equipment 1100 may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

For example, the processor 1110 may be configured to execute a program to carry out the information transceiving method as described in the embodiment of the first aspect. For example, the processor 1110 may be configured to perform the following control: transmitting request information for acquiring an AI model to a network device; and receiving feedback information transmitted by the network device in response to the request information.

As shown in FIG. 11, the terminal equipment 1100 may further include a communication module 1130, an input unit 1140, a display 1150, and a power supply 1160; wherein functions of the above components are similar to those in the related art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the related art may be referred to.

Embodiments of this disclosure provide a computer readable program, which, when executed in a terminal equipment, causes the terminal equipment to carry out the information transceiving method as described in the embodiments of the first aspect.

Embodiments of this disclosure provide a computer storage medium, including a computer readable program, which causes a terminal equipment to carry out the information transceiving method as described in the embodiments of the first aspect.

Embodiments of this disclosure provide a computer readable program, which, when executed in a network device, causes the network device to carry out the information transceiving method as described in the embodiments of the second aspect.

Embodiments of this disclosure provide a computer storage medium, including a computer readable program, which causes a network device to carry out the information transceiving method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. An information transceiving method, characterized in that the method includes:
transmitting request information for acquiring an AI model by a terminal equipment to a network device; and
receiving, by the terminal equipment, feedback information transmitted by the network device in response to the request information.
2. The method according to supplement 1, wherein the request information includes function identifier information of the AI model and/or parameter information of the AI model and/or capability information of the AI model supported by the terminal equipment.
3. The method according to supplement 2, wherein the capability information includes a maximum first calculation amount and/or a first storage space that the terminal equipment is able to support for deployment of the AI model.
4. The method according to any one of supplements 1-3, wherein the feedback information includes indication information on whether to support a request of the terminal equipment and/or relevant identifier information of the AI model and/or a complexity of the AI model.
5. The method according to supplement 4, wherein the relevant identifier information of the AI model is used to identify a function of the AI model and/or parameter information of AI models with same function and/or an index of the AI model in multiple AI models with same function and same parameter.
6. The method according to supplement 5, wherein the relevant identifier information of the AI model includes first identifier information and/or second identifier information and/or third identifier information, the first identifier information being a function identifier of the AI model, the second identifier information being the parameter information of the AI models with same function, and the third identifier information being the index of the AI model in the multiple AI models with same function and same parameter.
7. The method according to any one of supplements 4-6, wherein the complexity of the AI model includes a second calculation amount and/or a second storage space actually on-demand in deploying the AI model.
8. The method according to any one of supplements 1-7, wherein the request information is carried by RRC or an MAC CE or UCI.
9. The method according to any one of supplements 1-8, wherein the feedback information is carried by RRC or an MAC CE or DCI.
10. The method according to any one of supplements 1-9, wherein the function of the AI model refers to a part of functions in a receiving and/or transmitting link of the terminal equipment.
11. The method according to supplement 10, wherein the function of the AI model includes an AI encoder model for CSI compression or an AI model for beam prediction or an AI model for positioning the terminal equipment.
12. The method according to any one of supplements 1-11, wherein the method further includes:
receiving, by the terminal equipment, transmission resource allocation information of the AI model transmitted by the network device, the resource allocation information being used for indicating a time-frequency domain resource needed in transmitting the AI model.
13. The method according to supplement 12, wherein the method further includes:
receiving, by the terminal equipment, the AI model transmitted by the network device on the time-frequency domain resource.
14. The method according to supplement 12, wherein the terminal equipment receives the resource allocation information when the network device supports the request of the terminal equipment.
15. An information transceiving method, characterized in that the method includes:
receiving, by a network device, request information transmitted by a terminal equipment for acquiring an AI model; and
transmitting feedback information in response to the request information by the network device to the terminal equipment.
16. The method according to supplement 15, wherein the request information includes function identifier information of the AI model and/or parameter information of the AI model and/or capability information of the AI model supported by the terminal equipment.
17. The method according to supplement 15 or 16, wherein the feedback information includes indication information on whether to support a request of the terminal equipment and/or relevant identifier information of the AI model and/or a complexity of the AI model.
18. The method according to supplement 16 or 17, wherein the method further includes:
matching with AI models stored in the network device by the network device according to a function of the AI model and/or parameter information of the AI model and/or capability information requested by the terminal equipment to determine whether there exists an AI model satisfying the request of the terminal equipment in the AI models stored in the network device;
and the network device transmits the feedback information based on a matching result.
19. The method according to any one of supplements 15-18, wherein the method further includes:
transmitting transmission resource allocation information of the AI model by the network device to the terminal equipment, the resource allocation information being used to indicate a time-frequency domain resource needed in transmitting the AI model, and transmitting the AI model to the terminal equipment on the time-frequency domain resource.
20. A network device, including a memory and a processor, the memory storing a computer program, and the processor being configured to execute the computer program to carry out the method as described in any one of supplements 15-19.
21. A terminal equipment, including a memory and a processor, the memory storing a computer program, and the processor being configured to execute the computer program to carry out the method as described in any one of supplements 1-14.

What is claimed is:

1. An information transceiving apparatus, applicable to a terminal equipment, the apparatus comprising:
a transmitter configured to transmit third information for acquiring an AI model to a network device; and
a receiver configured to receive fourth information transmitted by the network device in response to the third information.

2. The apparatus according to claim 1, wherein the third information at least comprises function identifier information of the AI model and/or parameter information of the AI model and/or capability information of the AI model supported by the terminal equipment.

3. The apparatus according to claim 2, wherein the capability information at least comprises a maximum first calculation amount and/or a first storage space that the terminal equipment is able to support for deployment of the AI model.

4. The apparatus according to claim 1, wherein the fourth information at least comprises indication information on whether to support a request of the terminal equipment and/or relevant identifier information of the AI model and/or a complexity of the AI model.

5. The apparatus according to claim 4, wherein the relevant identifier information of the AI model is at least used to identify a function of the AI model and/or parameter information of AI models with same function and/or an index of the AI model in multiple AI models with same function and same parameter.

6. The apparatus according to claim 5, wherein the relevant identifier information of the AI model at least comprises first identifier information and/or second identifier information and/or third identifier information, the first identifier information being a function identifier of the AI model, the second identifier information being the parameter information of the AI models with same function, and the third identifier information being the index of the AI model in the multiple AI models with same function and same parameter.

7. The apparatus according to claim 4, wherein the complexity of the AI model at least comprises a second calculation amount and/or a second storage space actually on-demand in deploying the AI model.

8. The apparatus according to claim 1, wherein the third information is carried by RRC or an MAC CE or UCI.

9. The apparatus according to claim 1, wherein the fourth information is carried by RRC or an MAC CE or DCI.

10. The apparatus according to claim 1, wherein the function of the AI model refers to a part of functions in a receiving and/or transmitting link of the terminal equipment.

11. The apparatus according to claim 10, wherein the function of the AI model at least comprises an AI encoder model for CSI compression or an AI model for beam prediction or an AI model for positioning the terminal equipment.

12. The apparatus according to claim 1, wherein,
the receiver is further configured to receive transmission resource allocation information of the AI model transmitted by the network device, the resource allocation information at least being used for indicating a time-frequency domain resource needed in transmitting the AI model.

13. The apparatus according to claim 12, wherein,
the receiver is further configured to receive the AI model transmitted by the network device on the time-frequency domain resource.

14. The apparatus according to claim 12, wherein the receiver receives the resource allocation information when the network device supports the request of the terminal equipment.

15. An information transceiving apparatus, applicable to a network device, the apparatus comprising:
a receiver configured to receive third information transmitted by a terminal equipment for acquiring an AI model; and
a transmitter configured to transmit fourth information in response to the third information to the terminal equipment.

16. The apparatus according to claim 15, wherein the third information at least comprises function identifier information of the AI model and/or parameter information of the AI model and/or capability information of the AI model supported by the terminal equipment.

17. The apparatus according to claim 15, wherein the fourth information at least comprises indication information on whether to support a request of the terminal equipment and/or relevant identifier information of the AI model and/or a complexity of the AI model.

18. The apparatus according to claim 16, the apparatus further comprising:
processor circuitry configured to match with AI models stored in the network device at least according to a function of the AI model and/or parameter information of the AI model and/or capability information requested by the terminal equipment to determine whether there exists an AI model satisfying the request of the terminal equipment in the AI models stored in the network device;
and the transmitter transmits the fourth information based on a matching result of the processor.

19. The apparatus according to claim 15, wherein,
the transmitter is further configured to transmit transmission resource allocation information of the AI model to the terminal equipment, the resource allocation information at least being used to indicate a time-frequency domain resource needed in transmitting the AI model, and transmit the AI model to the terminal equipment on the time-frequency domain resource.

20. A communication system, comprising a terminal equipment and/or a network device, the terminal equipment comprising:
a first transmitter configured to transmit third information for acquiring an AI model to a network device; and
a first receiver configured to receive fourth information transmitted by the network device in response to the third information, and
a network apparatus comprising
a second receiver configured to receive the third information transmitted by a terminal equipment for acquiring an AI model; and
a second transmitter configured to transmit the fourth information in response to the third information to the terminal equipment.
